(19) United States
(12) Patent Application Publication
(10) Pub. No.: US 2009/0046668 A1
(43) Pub. Date: Feb. 19, 2009

(54) Method and system for detecting and identifying scrambling codes

(75) Inventors: Sharad Sambhwani, San Diego, CA (US); Ghobad Heidari, San Diego, CA (US)

Correspondence Address: NIXON PEABODY, LLP, 401 9TH STREET, NW, SUITE 900, WASHINGTON, DC, 20004-2128, US

(73) Assignee: QST Holdings, LLC, Palo Alto, CA (US)

(21) Appl. No.: 12/247,403

(22) Filed: Oct. 8, 2008

Related U.S. Application Data
(63) Continuation of application No. 10/295,632, filed on Nov. 14, 2002.
Application No. 10/295,632 is a continuation-in-part of application No. 10/015,537, filed on Dec. 12, 2001, now Pat. No. 7,139,256.

(51) Int. Cl. H04B 7/216; H04B 1/707

(52) U.S. Cl. 370/335; 375/150; 375/E01.002

(57) ABSTRACT

A system for detecting and identifying a scrambling code in received signals. According to one aspect of the system, the system is used to perform scrambling code detection of eight (8) primary cells (each scrambling code being spaced sixteen (16) chips apart) in a group. According to another aspect of the system, a single scrambling code generator is used to generate sequential chips of a master scrambling code. The sequential chips are used to create individual segments which are used in correlation with received signals to detect in parallel which one of the eight (8) possible primary cells in the group transmitted the received signals.

### CROSS-REFERENCES TO RELATED APPLICATION(S)

This application is a continuation of U.S. patent application Ser. No. 10/295,632, filed Nov. 14, 2002, which is a continuation-in-part of U.S. patent application Ser. No. 10/015,537 filed on Dec. 12, 2001, now U.S. Pat. No. 7,139,256, issued Nov. 29, 2006, the disclosures of each of the aforementioned applications are hereby incorporated by reference in their entirety as if set forth in full herein for all purposes.

### BACKGROUND OF THE INVENTION

The present invention generally relates to scrambling codes. More specifically, the present invention relates to a method and system for detecting scrambling codes within a communication system.

Code acquisition is a fundamental algorithm required in any direct sequence spread spectrum (DSSS) receiver Prior to de-spreading, demodulating and decoding frames, such a receiver needs to acquire knowledge of timing information relating to the underlying spreading waveform being used to spread the data-bearing signal. According to the wide-band code division multiple access (W-CDMA) communication system of the 3GPP standards body, upon turning on a mobile terminal or device, a 3-step initial cell search procedure needs to be performed to acquire the primary scrambling code which is used to spread the data bearing channels Examples of such channels are the primary common pilot channel (P-CPICH) and the dedicated physical channel (DPCH).

The first step of the 3-step initial cell search procedure relates to slot timing. In a W-CDMA communication system, each base station transmits its own scrambling code in frames over the air to a mobile terminal. Each frame is made up of fifteen (15) slots. Before the start of a frame can be located, the start of a slot needs to be identified first. Once the start of a slot is identified, then it can be assured that one of the next fifteen (15) slots represents the start of a frame. Upon conclusion of the first step, the start of a slot is identified.

The second step of the 3-step initial cell search procedure relates to frame timing. As mentioned above, at the end of the first step, the start of a slot is identified. Once that is achieved, the start of a frame can then be identified. Within a W-CDMA communication system, there are five hundred and twelve (512) base stations within the network. The base stations are identified in the network by a network matrix. The network matrix has sixty-four groups (64) and each group has eight (8) cells. A particular base station is identified by its group and its cell position within the group. During this second step, the start of a frame is identified and the mobile terminal can then synchronize to the identified frame and obtain information relating to group identification. Upon conclusion of the second step, the group which contains the base station that sent out the frame (or scrambling code) is identified, i.e., one out of sixty-four (64) group is identified.

Upon completing the first two steps of the initial cell search procedure, the receiver has knowledge of the slot and frame timing of the received scrambling code, such as a P-CPICH signal. The receiver also has knowledge of the group identification of the base station or cell being acquired. The group identification information contains information on all eight (8) primary cells within the group. Since there are eight (8) cells in a group, using the group identification information, the receiver needs only to identify one (1) out of eight (8) possible primary cells from the group.

To achieve this goal, the receiver may use one of two conventional approaches. Under the first approach, the receiver may perform a correlation of the received signals with a parallel bank of eight (8) scrambling code generators (typical correlation length N ranges from 64 to 256 chips based on frequency offset in the received signals). All the eight (8) correlations are performed within N chips, at the expense of using eight (8) parallel scrambling code generators.

Under the second approach, the receiver may sequentially correlate the received signals with eight (8) possible scrambling codes for N chips each. Using a single scrambling code generator, one may attain all eight (8) correlation results after slightly greater than 8*N chips (this number of chips is needed to allow for reassigning the scrambling code generator to another phase offset, after each correlation is performed),

Implementations may not be limited to the above two conventional approaches. The above two approaches were explained for the case of real time processing of the CDMA signal, i.e. no buffering of received data was assumed for these two cases.

As mentioned above, the eight (8) scrambling codes may be generated in parallel, using eight (8) separate scrambling code generators each operating independently, or the eight (8) scrambling codes maybe generated using a single scrambling code generator using eight (8) sets of masks (a set=4 18-bit masks). However, both of these approaches require additional power consumption/silicon area. Under the first approach, additional scrambling code generators are needed; and under the second approach, additional memory storage is needed to store the received signals and it takes additional time to generate and process the necessary scrambling codes in a sequential manner.

Hence, it would be desirable to provide a method and system which is capable of generating scrambling codes for correlation to identify a received scrambling code in a more efficient manner.

### SUMMARY OF THE INVENTION

An exemplary method of the present invention is used to perform scrambling code detection of eight (8) primary cells (each scrambling code's X-component being spaced sixteen (16) chips apart) in a group. According to the exemplary method, a single scrambling code generator is used to generate a master scrambling code. The master scrambling code is then used to create individual scrambling codes which are used in correlation with received signals to detect in parallel which one of the eight (8) possible primary cells in the group transmitted the received signals. Each individual scrambling code has a X-component and a Y-component. The individual scrambling codes are created based on the fact that the X-component of each cell station's scrambling code's phase reference is spaced sixteen (16) chips apart. The use of this exemplary method reduces the complexity of scrambling code or PN generator(s) in the parallel search implementation.

The use of this exemplary method also avoids the need to utilize parallel logic to generate eight (8) scrambling codes. Since the X-component of each primary scrambling code within a group is sixteen (16) chips apart, a pair of buffers (one for the X-component and one for the Y-component) is used to store a sequential stream of X- and Y-components of the complex scrambling code (i.e., the master scrambling code) output from a single scrambling code generator. Using different 16-chip offsets in the X-component buffers (complex samples) and a common Y-component buffer (complex samples), all eight (8) different complex primary scrambling codes can be generated. The received data is then correlated in parallel with each of the eight (8) individual scrambling codes generated from the master scrambling code. Eight dimensions are mapped to a single dimension at the expense of a slight increase in storage size.

This exemplary method can be used as part of an overall 3-step initial cell search procedure to acquire the downlink of a 3GPP WCDMA cell, which more specifically corresponds to part of the stage 3 portion of the cell search procedure.

Reference to the remaining portions of the specification, including the drawings and claims, will realize other features and advantages of the present invention. Further features and advantages of the present invention, as well as the structure and operation of various embodiments of the present invention, are described in detail below with respect to accompanying drawings, like reference numbers indicate identical or functionally similar elements.

### BRIEF DESCRIPTION OF THE DRAWINGS

FIG. 1A is a simplified diagram illustrating the timing of the X-components of the scrambling codes of the eight (8) cells within a group;

FIG. 1B is a simplified diagram illustrating the timing of the Y-components of the scrambling codes of the eight (8) cells within a group;

FIG. 2 is a flow diagram illustrating an exemplary method of the present invention;

FIG. 3 is a simplified diagram illustrating parallel correlations of eight (8) cells in a group using a single scrambling code generator according to the present invention; and

FIG. 4 is a simplified diagram illustrating an exemplary implementation of the exemplary method according to the present invention.

### DETAILED DESCRIPTION OF THE INVENTION

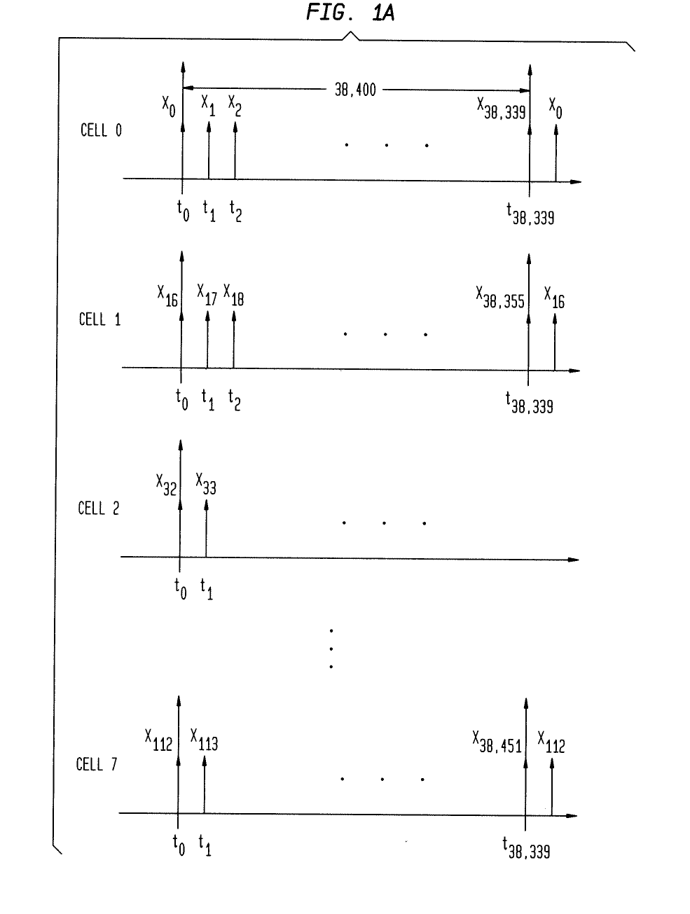

The present invention in the form of one or more exemplary embodiments will now be discussed. The present invention can be applied to the third step of the initial cell search procedure when a mobile terminal is initially powered on to identify the base station or cell which transmitted the received signals containing a scrambling code. FIG. 1A is a simplified diagram illustrating the timing of the X-components of the scrambling codes of the eight (8) cells within a group. Referring to FIG. 1A, the scrambling code of each cell is transmitted on a periodic basis and the period of the scrambling code of each cell is thirty-eight thousand and four hundred (38,400) chips, i.e., the scrambling code of each cell is repeated after 38,400 chips. For example, for cell “0”, X₀ is generated internally within a scrambling code generator at t₀ and at t_{38,400}. Furthermore, the X-components of the scrambling codes of any two adjacent cells are offset by sixteen (16) chips. For example, cells “0” and “1” generate internally X₀ and X₁₆ respectively at t₀. The scrambling codes of all the cells within the group are transmitted at the same frame boundary. By having a 16-chip offset between two adjacent cells, the X-components of the scrambling codes between two adjacent groups of cells are offset by one hundred and twenty-eight (128) (16*8=128). It should be noted that the Y-components of all the scrambling codes are the same, i.e., there is no offset between the Y-components of adjacent scrambling codes. FIG. 1B is a simplified diagram illustrating the timing of the Y-components of the scrambling codes of the eight (8) cells within a group.

According to one exemplary method of the present invention, a scrambling code represented by the received signals is identified by using a single scrambling code generator to attain N chip correlation of the received signals with eight (8) primary scrambling codes in a group within N+16*7=N+112 chips.

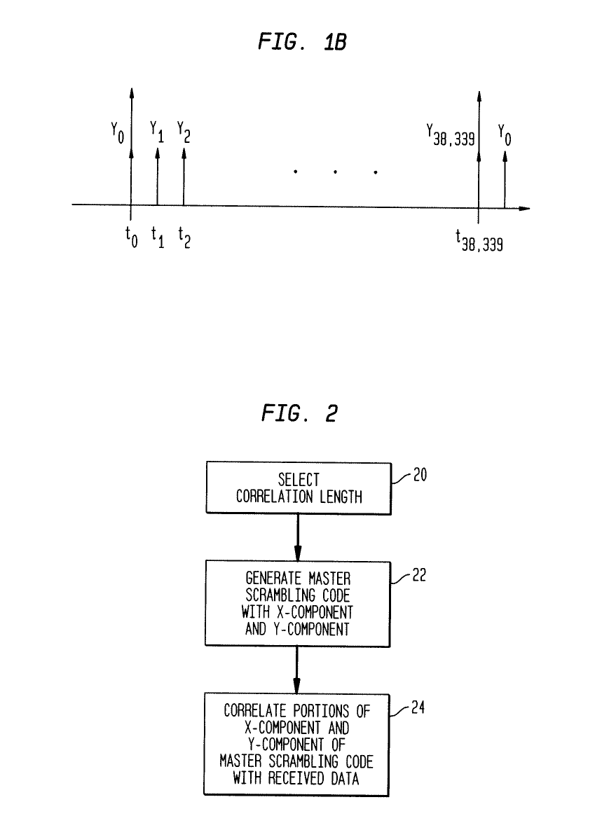

FIG. 2 is a flow diagram illustrating an exemplary method of the present invention. Referring to FIG. 2, at 20, the correlation length N is first determined. The correlation length N is the amount of time during which correlation between the received signals and the generated scrambling codes is summed up. The correlation length N is selected such that reasonable correlation results can be obtained. A person of ordinary skill in the art will know how to select the proper correlation length. Next, at 22, using the selected correlation length, the chip offset (CO) between two adjacent scrambling codes, and the number of cells (C) within a group, a master scrambling code is generated. The master scrambling code has a X-component and a Y-component. The X-component and the Y-component are respectively stored in a X-component buffer and a Y-component buffer for subsequent use in generating possible scrambling codes from all the cells in an identified group. The master scrambling code has a period, e.g., 38,400 chips, which is sufficient to allow correlations to be performed reliably. N+CO*(C−1) corresponds to the amount of the code's X-component that needs to be generated to perform a correlation of length N with C cells spaced CO chips apart. Also, at the same time, N complex samples of the code's Y-component needs to be generated. It should be noted that the product term CO*C represents the chip offset between the X-components of the respective scrambling codes of the first cells of two adjacent groups of base stations or cells. As mentioned above, during the first two steps of the initial cell search procedure, the start of the frame containing the scrambling code is identified and group identification information relating to the group which includes the cell that transmitted the received signals is available. With this information, the group which includes the cell that transmitted the received signals is identified. Moreover, using this information, the proper master scrambling code which covers all the possible scrambling codes from all the cells within the identified group can be generated. At 24, portions of the master scrambling code's X-component buffer are used, along with the common Y-component buffer, to create individual scrambling codes which correspond to the cells within the identified group. These individual scrambling codes are then correlated with the received signals in a parallel manner to determine which of the cells within the identified group transmitted the received signals.

The following is an example illustrating the exemplary method of the present invention. The example is based on the following assumptions: the correlation length N is two hundred and fifty-six (256); the chip offset CO is sixteen (16); and the number of cells C within the identified group is eight (8). The period of the master scrambling code is thirty-eight thousand and four hundred (38,400) chips.

Next, three hundred and sixty-eight (368) chips (X₀>X₃₆₇) of the master scrambling code's X-component, as well as two hundred and fifty-six (256) chips (Y₀>Y₂₅₅) of the master scrambling code's Y-component, are generated from a single scrambling code generator tuned to the first primary cell of the underlying identified group. The length of three hundred and sixty-eight (368) chips is determined based on the formula N+CO*(C−1) which, in this case, equals to 256+16*(8−1)=256+16*7=256+112=368. The length of chips for the Y-component is determined by the correlation length N, which in this case is two hundred and fifty-six (256). It should be noted that it is not necessary to generate all three hundred and sixty-eight (368) X-component chips and all two hundred and fifty-six (256) Y-component chips prior to correlation. The generation of three hundred and sixty-eight (368) chips is specified to emphasize the total number of chips required out of the scrambling code generator's X-component to implement eight (8) parallel correlations of two hundred and fifty-six (256) chips each.

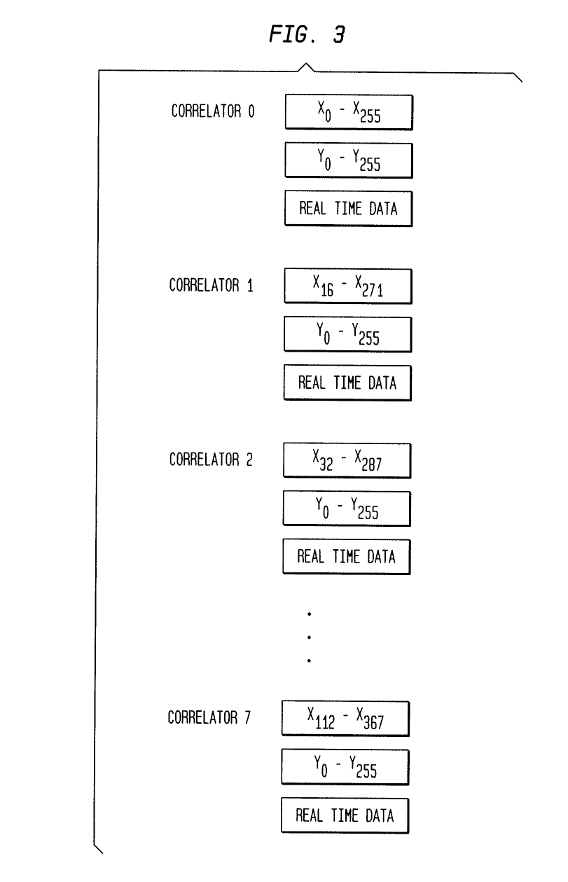

FIG. 3 is a simplified diagram illustrating parallel correlations of eight (8) cells in a group using a single scrambling code generator. As shown in FIG. 3, each of the eight (8) correlators correlates the received signals or real-time data (D₀>D₂₅₅) with two hundred and fifty-six (256) X-component chips and two hundred and fifty-six (256) Y-component chips. The respective X-component chips for the correlators are each generated by operating on different portions of the X-component buffer. As mentioned above, the X-component buffer contains the X-component of the master scrambling code. Furthermore, the respective X-component chips of two adjacent correlators are started at an offset of sixteen (16) chips. The Y-component chips are the same for all correlators. It should be noted that the contents of the X-component buffer and Y-component buffer are complex. For example, the first correlator correlates the received signals (D₀>D₂₅₅) with the X-component chips (X₀>X₂₅₅) and with the Y-component chips (Y₀>Y₂₅₅); the second correlator correlates the received signals (D₀>D₂₅₅) with the X-component chips (X₁₆>X₂₇₁) and again with the Y-component chips (Y₀>Y₂₅₅); and so on, and the final correlator correlates the received signals (D₀>D₂₅₅) with the X-component chips (X₁₁₂>X₃₆₇) and also with Y-component chips (Y₀>Y₂₅₅). The correlation results are then obtained from each of the correlators. By evaluating the correlation results, the scrambling code represented by the received signals can be identified and, hence, the identity of the base station or cell which transmitted the received signals can also be determined.

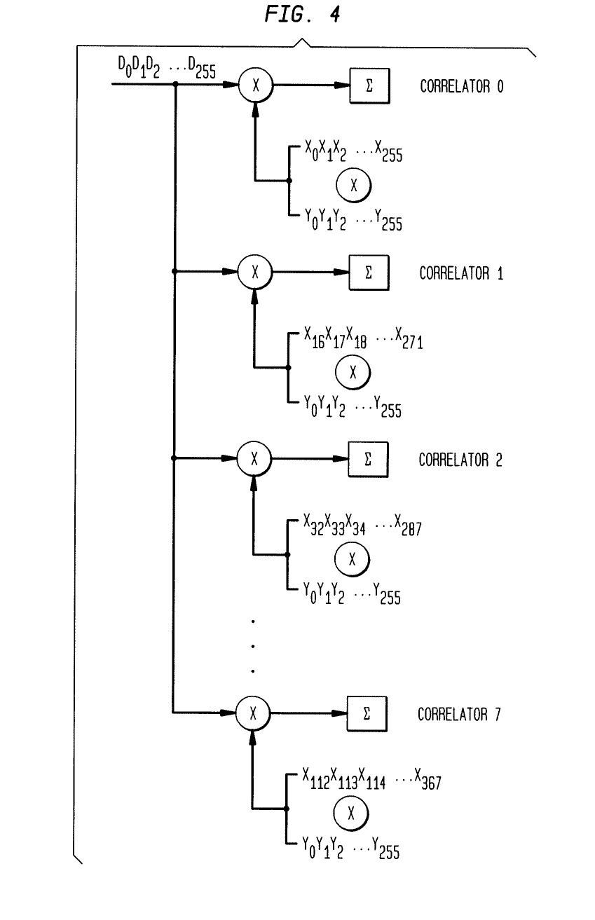

FIG. 4 is a simplified diagram illustrating an exemplary implementation of the exemplary method in accordance with the present invention. It is to be noted that the received signals are processed simultaneously in real-time by eight (8) parallel correlators. The scrambling code generator generates an X-component buffer that is three hundred and sixty-eight (368) chips long, i.e., N+112 chips, and a Y-component buffer that is two hundred and fifty-six (256) chips long. This is in contrast to 8*N*2 (8*N for the X-component and 8*N for the Y-component) complex chips that must be generated for the alternative approach in the parallel search implementation. Hence, there is a factor of 8N*2/(2N+128) savings on the scrambling code generation complexity using the present invention, which equals to 6.4 for N=256 (an 85% reduction in complexity).

The exemplary method of the present invention as described may be implemented in software, hardware or a combination of both. For example, the exemplary method of the present invention may be implemented as control logic using software embedded in a mobile terminal. When implemented using software, the exemplary method may be implemented in a modular or integrated manner within the mobile terminal. Based on disclosure provided herein, a person of ordinary skill in the art will know of other ways and/or methods to implement the present invention.

Furthermore, it is understood that while the present invention as described above is applicable to a W-CDMA communication system, it should be clear to a person of ordinary skill in the art that the present invention can be applied to other types of communication systems.

It is further understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference for all purposes in their entirety.

What is claimed is:

1. A system for identifying a scrambling code in received signals, the scrambling code being one of a plurality of scrambling codes, the system comprising:
a scrambling code generator adapted to generate a plurality of sequential chips of a master scrambling code, the plurality of sequential chips comprising a plurality of segments, each of the plurality of segments being associated with a corresponding one of the plurality of scrambling codes, any two adjacent segments being separated by a predetermined chip offset; and
a plurality of correlators adapted to perform in parallel respective correlations of the received signals with respective ones of the segments to generate parallel correlation results from which the scrambling code can be identified.

2. The system of claim 1, wherein the correlation results generated by the plurality of correlators are evaluated to identify the scrambling code from the received signals to determine the identity of a base station which transmitted one of the received signals.

3. The system of claim 1, wherein the plurality of correlators perform the respective correlations in real-time.

4. A mobile terminal incorporating the system of claim 1.

5. The system of claim 2, wherein the base station is in a Code Division Multiple Access (CDMA) communication network.

6. The system of claim 5, wherein the Code Division Multiple Access (CDMA) communication network is a Wide-band Code Division Multiple Access (W-CDMA) communication network.

7. A system of claim 1, wherein at least one of the received signals is from a base station, the base station belonging to one of a plurality of base station groups in a communication network.

8. The system of claim 1, wherein a total length of the sequential chips generated is determined by a selected correlation length and a predetermined group chip offset.

9. The system of claim 8, wherein the predetermined group chip offset is determined by number of base stations in a base station group and the predetermined chip offset.

10. The system of claim 1, further comprising a buffer adapted to store the sequential chips generated by the scrambling code generator, wherein the plurality of segments provided to the plurality of correlators are formed from the sequential chips stored in the buffer.

11. A method for identifying a scrambling code in received signals, the scrambling code being one of a plurality of scrambling codes, the method comprising:
generating a plurality of sequential chips of a master scrambling code, the plurality of sequential chips comprising a plurality of segments, each of the plurality of segments being associated with a corresponding one of the scrambling codes, any two adjacent segments being separated by a predetermined chip offset; and
correlating in parallel the received signals with respective ones of the segments to generate parallel correlation results from which the scrambling code can be identified.

12. The method of claim 11, further comprising:
evaluating the correlation results to identify the scrambling code from the received signals to determine the identity of a base station which transmitted one of the received signals.

13. The method of claim 11, further comprising:
selecting a correlation length; and
wherein a total length of the sequential chips correlated depends on the selected correlation length and a predetermined group chip offset.

14. The method of claim 13, wherein the predetermined group chip offset is determined by number of base stations in a base station group in a communication network and the predetermined chip offset between two adjacent base stations in the base station group.

15. The method of claim 11, wherein the respective correlations are performed in real-time.

16. A mobile terminal utilizing the method of claim 11.

17. The method of claim 11, wherein the base station is in a Code Division Multiple Access (CDMA) communication network.

18. The method of claim 17, wherein the Code Division Multiple Access (CDMA) communication network is a Wide-band Code Division Multiple Access (W-CDMA) communication network.

19. The method of claim 11, further comprising:
buffering the sequential chips generated by the scrambling code generator, and
forming the plurality of segments provided to the plurality of correlators from the buffered sequential chips.

20. A system for identifying a scrambling code in signals received from a base station, the scrambling code being one of a plurality of scrambling codes, the system comprising:
means for generating a plurality of sequential chips of a master scrambling code, the plurality of sequential chips comprising a plurality of segments, each of the plurality of segments being associated with a corresponding one of the scrambling codes, wherein any two adjacent segments are separated by a predetermined chip offset; and
means for correlating in parallel the received signals with respective ones of the segments to generate parallel correlation results from which the scrambling code can be identified.

21. The system of claim 20, further comprising:
means for evaluating the correlation results to identify the scrambling code from the received signals to determine the identity of the base station which transmitted one of the received signals.

22. The system of claim 20, wherein the means for correlating performs its correlations in real-time.

23. A mobile terminal utilizing the system of claim 20.

24. The system of claim 20, wherein the base station is in a Code Division Multiple Access (CDMA) communication network.

25. The system of claim 24, wherein the Code Division Multiple Access (CDMA) communication network is a Wide-band Code Division Multiple Access (W-CDMA) communication network.

26. The system of claim 20, further comprising:
means for buffering the sequential chips generated by the scrambling code generator, and
means for forming the plurality of segments provided to the plurality of correlators from the buffered sequential chips.
